(19) United States
(12) Patent Application Publication
(10) Pub. No.: US 2012/0112024 A1
(43) Pub. Date: May 10, 2012

(54) CLAMP HOLDER FOR ATTACHING A DISPLAY MEANS TO A BASE

(76) Inventor: Werner Gõtzl, Erbendorf (DE)

(21) Appl. No.: 13/381,859

(22) PCT Filed: Jun. 2, 2010
(86) PCT No.: PCT/EP10/57702

§ 371 Date: Dec. 30, 2011

(30) Foreign Application Priority Data
Jul. 1, 2009 (DE) 10 2009 031 354.0

(51) Int. Cl. F16B 2/24; F16B 2/10; F16M 13/02

(52) U.S. Cl. 248/231.81; 248/226.11

(57) ABSTRACT

The invention relates to a clamp holder for attaching a display means to a base. The clamp holder comprises a holding element. The holding element is provided at one end with a first clamp member for fitting the display means and at a second end with a second clamp member for attaching the holding element to the base. The clamp members are spaced apart from each other by a fixed member. The first clamp member defines a first clamp plane, which is offset by an angle (α) to a second clamp plane defined by the second clamp member.

The invention relates to a clamp holder for attaching a display means to a base.

Various clamp holders are known in the prior art. For example, DE 201 09 286 U1 discloses a flag holder with clamp fitting. The clamp fitting is provided at the lower end of the flagpole for attaching the flagpole to a windscreen of a passenger vehicle. A flag can be attached to the flagpole in the conventional way.

DE 202 14 737 U1 discloses another flag with fitting. Here a clamp is provided at a lower end of a flagpole, said clamp also being bent in relation to the flagpole. A loop is provided on the flag for attaching the flag whereby said loop can be pushed over the flagpole.

A disadvantage of these flagpoles is seen wherein the flag must be specially made for attaching to the flagpoles, for example by the flag having a loop. In addition, the fittings are limited to the attachment of flags. No other objects can be usefully attached to the flagpoles such as, for example, name cards, pricing tickets, advertising slogans or descriptions.

On the basis of the prior art, the object of the invention is to demonstrate a clamp holder for attaching a display means to a base, said clamp holder displaying a wide flexibility with regard to the display means that can be attached to a clamp holder and with regard to the base on which the clamp holder can be fixed.

This object is achieved by a clamp holder with the features of claim 1.

The clamp holder according to the invention for attaching a display means to a base comprises a holding element. This holding element is provided at one end with a first clamp member for holding the display means and at a second end with a second clamp member for attaching the holding element to the base. The clamp members are spaced apart from each other by a fixed member. The first clamp member defines a first clamp plane which is offset by an angle α to a second clamp plane defined by the second clamp member.

The advantage of the invention lays therein that different types of display means, such as in particular flags or banners, paper or board cards, laminated cards and suchlike, can be attached to the first clamp member of the clamp holder. Then this clamp holder can be attached by clamping to a base, envisaged in particular as being spectacle frames, hat brims, cap brims, air grilles in cars, drinking glasses and mugs as well as crockery. In this way, for example, fans can advertise their loyalty to their home team or home country in a particularly simple and effective way. However, advertising cards or business cards can also be attached to the clamp holder and then worn by the user on their person.

Claims 2 to 25 relate to advantageous embodiments of the clamp holder.

In a preferred embodiment, the angle α is a right angle (90°). This ensures that if the clamp holder is fixed onto spectacles for example, the display means is visible and legible to an observer standing opposite the wearer.

The first clamp member can have at least two legs running parallel to each other. These legs enable any shape of a two-dimensional display means to be received.

In addition, it is advisable if a leg has at least one, preferably V-shaped, clamp shape. A clamp area is defined between the legs of the clamp member by the clamp shape, said area making it easier to attach the display means to the first clamp member. In this respect, provision can additionally be made for one of the legs to positively encompass another leg with a leg end. In this way a cross-member is relieved, which otherwise would have to apply the clamp force on its own.

In a preferred embodiment, at least one of the clamp members displays a helix or a spiral. Helices or spirals can be manufactured particularly easily and can be used to attach a display means to the clamp holder or to fix the clamp holder to a base.

According to a preferred embodiment, a helix or a spiral can display at least a protrusion. The diameter of the helix or spiral is locally widened by the protrusion, which preferably extends outwards in a radial direction and which makes it easier to fix or slot the clamp holder for example onto the leg of a pair of spectacles.

The clamp member preferably has several helices or spirals spaced apart from each other. This allows a display means to be attached at different points.

Particularly advantageous is an embodiment where a cover element, e.g. in the shape of a button, is detachably attached to a helix or a spiral. This can be clipped on but also pressed in or stuck on. The cover element covers the helix or the spiral and thus assures an optically advantageous impression to an observer. In addition, it can be used as a locking device for the second clamp member to the base.

Furthermore, it is envisaged that the cover element can display a printed external surface. A company logo, a coat of arms or a club logo, for example, can be printed onto this external surface. With such a printed cover element, the clamp holder is also suitable as an advertising means.

The holding element can be designed as one piece. This simplifies manufacturing. For example, using injection moulding, the clamp holder can be manufactured not only in the shape of a round cross-section but also, for example, in a square or rectangular or another suitable two-dimensional shape. It can also be stamped for from sheet metal for example.

The holding element is preferably manufactured from a piece of wire by bending. Even complicated shapes can be efficiently manufactured using the modern wire bending and forming machines.

It is advisable for an end of the wire in a clamp member to protrude inwards and form a bearing element. This bearing element prevents something from being able to be pushed right through the clamp member when being inserted. In this way, a secure seating is guaranteed, for example if the second clamp member is clipped onto a rectangular-sectioned leg of a pair of spectacles.

The end of the wire reaching inwards in a clamp member can be bent into an L-shape or Z-shape. In an L-shaped or Z-shaped design, the bearing element is advantageously widened and the bearing surface thereby enlarged. If thin objects are pushed onto the clamp member, it is not so easy for these to slip past the bearing element. In the case of thicker, more expansive objects, the large bearing surface guarantees a particularly stable grip, especially when the entire diameter of the clamp is pushed into the base. Alternatively, the end of the wire reaching inwards can have an eye. The eye has the advantage that it has no sharp-edged end protruding outwards due to its round shape.

The wire can be provided with a coating or sheathing. In particular, the wire can be copper-plated, brass-plated or chrome-plated. In addition, it is conceivable for a coat of paint to be applied to the wire. This coat of paint can be multi-coloured. Regional or club colours can be preferably applied to the clamp holder.

Furthermore, the wire can have at least a smoothed end. The smoothed end can be produced by deburring or grinding or be ready-made with a spherical end.

The clamp holder can additionally have a clamp member with an undulating section. Through the undulating section the friction resistance between the clamp member and the clamped-in object is increased to guarantee a secure grip.

The wire can be manufactured from spring steel. Spring steel improves the clamping force of the clamp members and extends the shelf life of the clamp holder.

The fixed member can be bent advantageously by an angle β. For this reason, a pressed-in reference bending point can be formed, e.g. with the wire pinched in a direction parallel to the plane of the lower clamp and at right angles to the length of the fixed member, in order to achieve easy handling when bending. In this way, the clamp holder can be used more flexibly. For example, it can then also be clipped horizontally onto a hat brim.

The display means can be a card of variable geometric shape or a banner. The card can have a credit card shape and be made of plastic. However, it is also conceivable that a board card is slotted into the first clamp member.

Further features and advantages of the invention will emerge from the following description of embodiments which are shown in the accompanying drawings, in which:

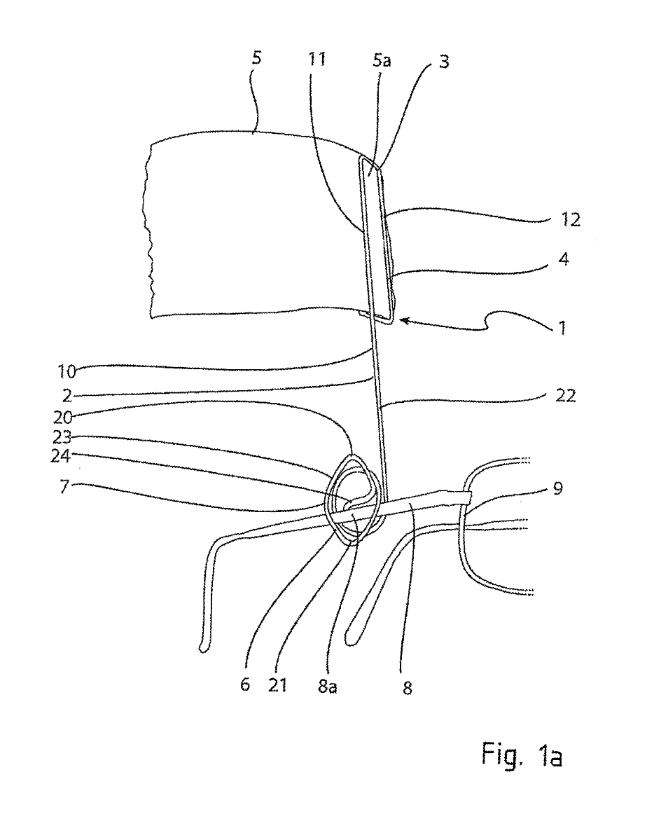

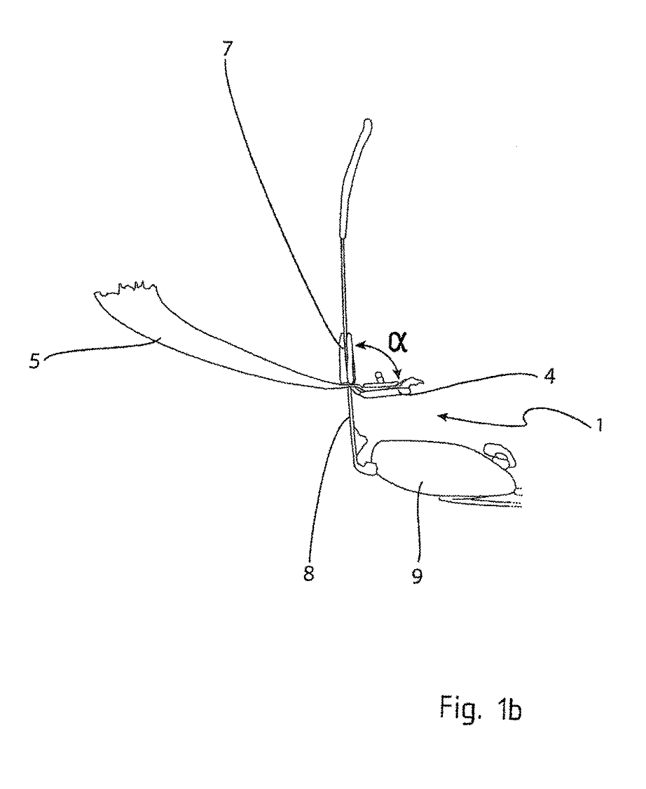

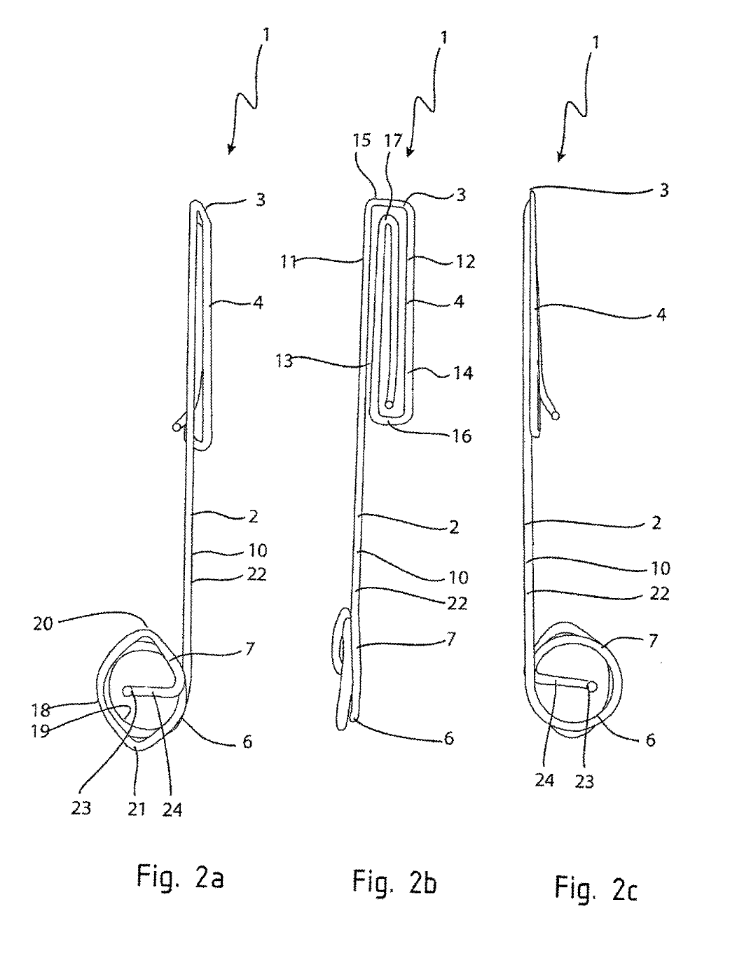

FIGS. 1a-1b and 2a-2c show a clamp holder with a four-legged first clamp member;

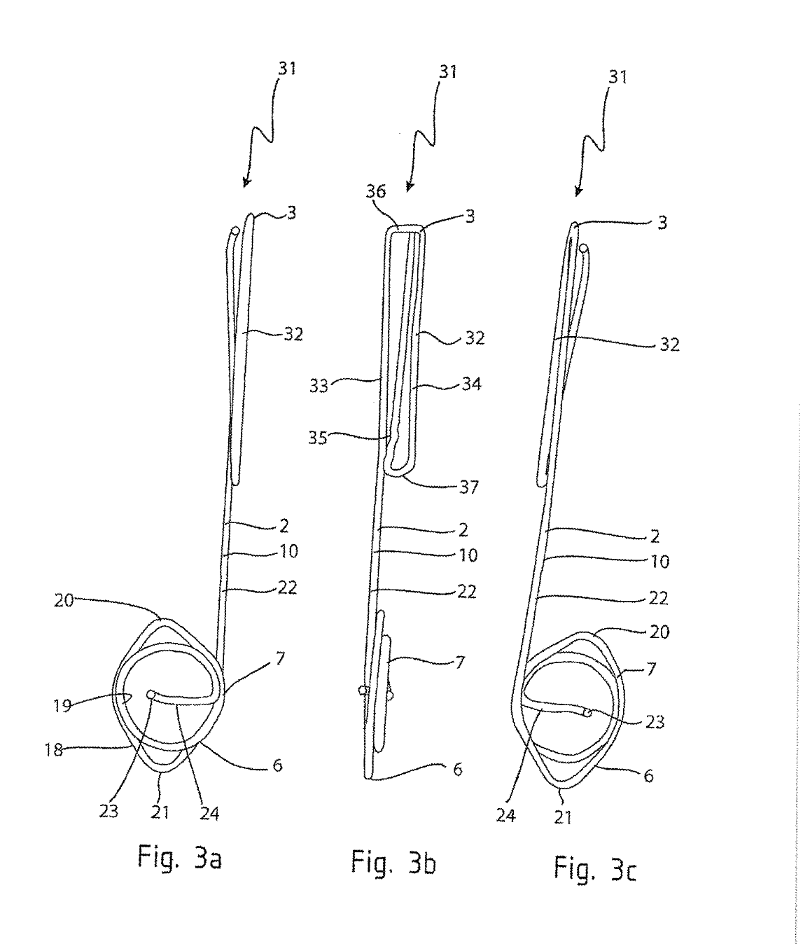

FIGS. 3a-3c show a clamp holder with a three-legged first clamp member;

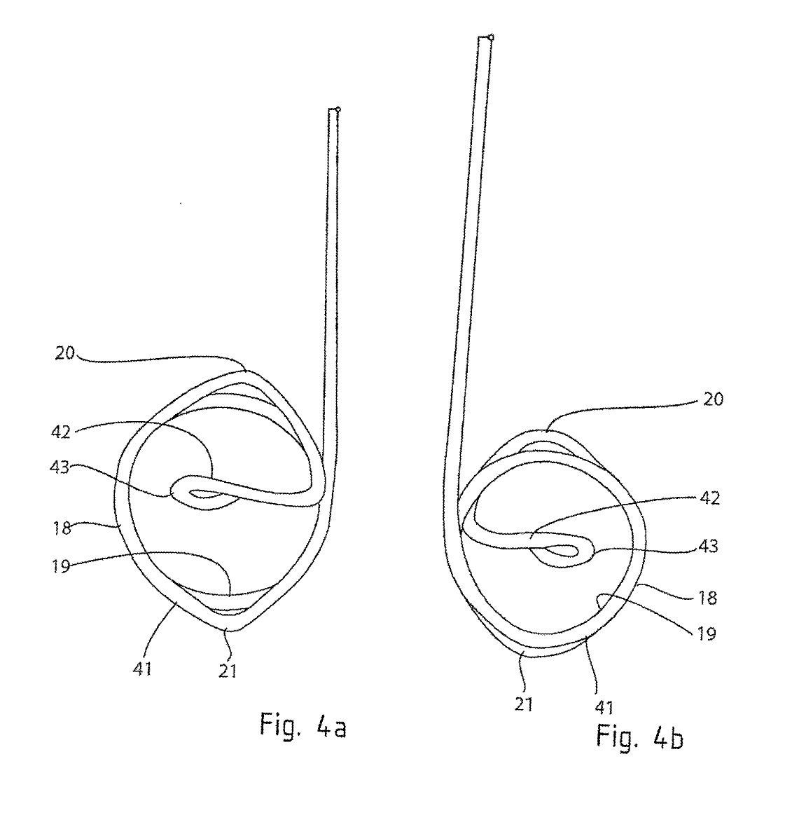

FIGS. 4a-4b show a section of an embodiment of the clamp holder in which a second clamp member is provided with an eye;

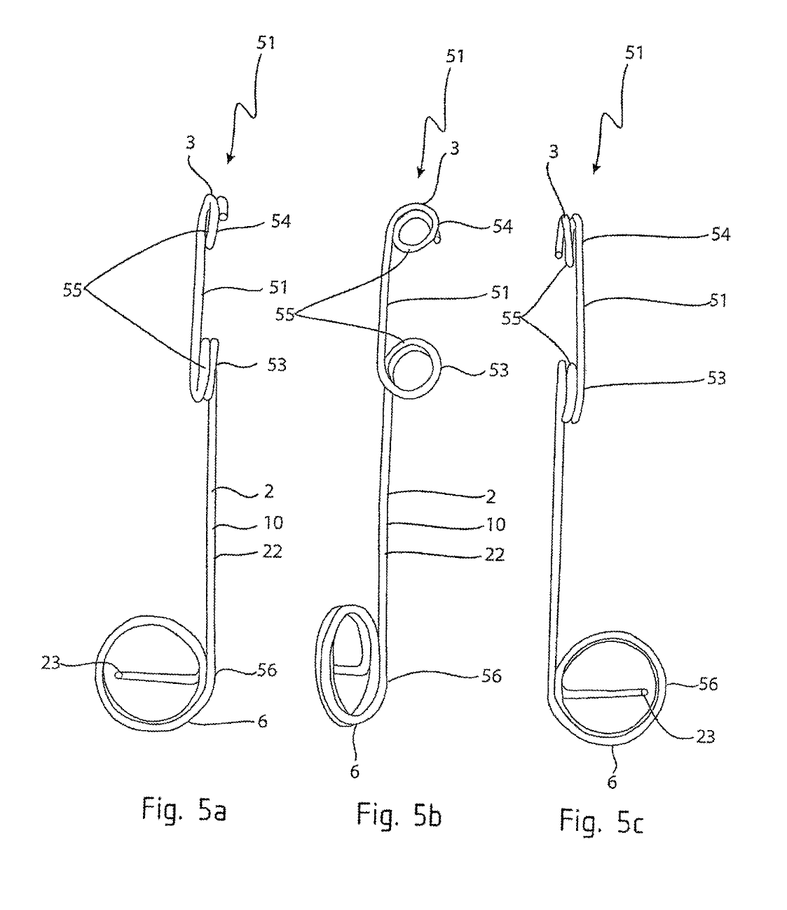

FIGS. 5a-5c show an embodiment of a clamp member which has helices spaced apart from each other on the first clamp member;

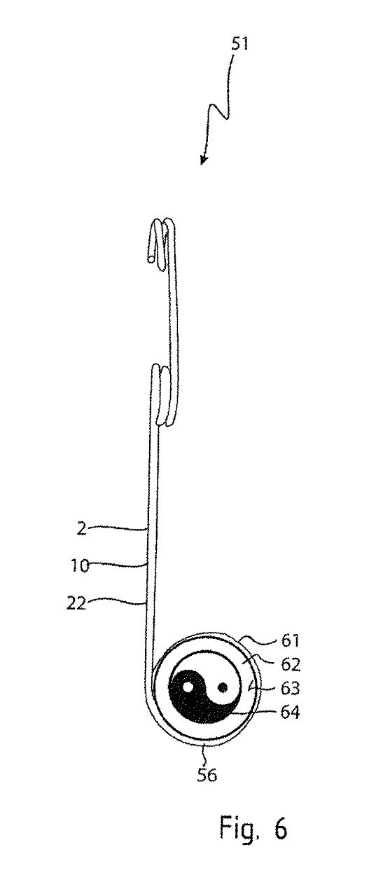

FIG. 6 shows an embodiment of the clamp holder in which a cover element is clipped into the second clamp member;

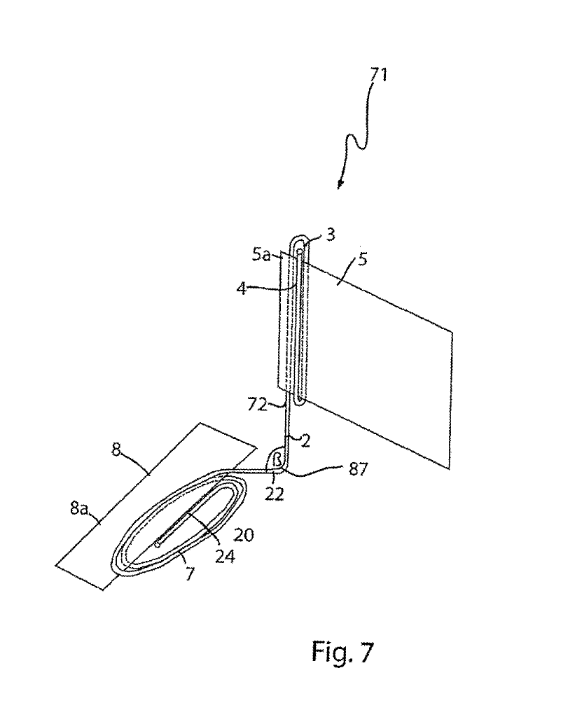

FIG. 7 shows an embodiment of the clamp holder with bent fixed member; and

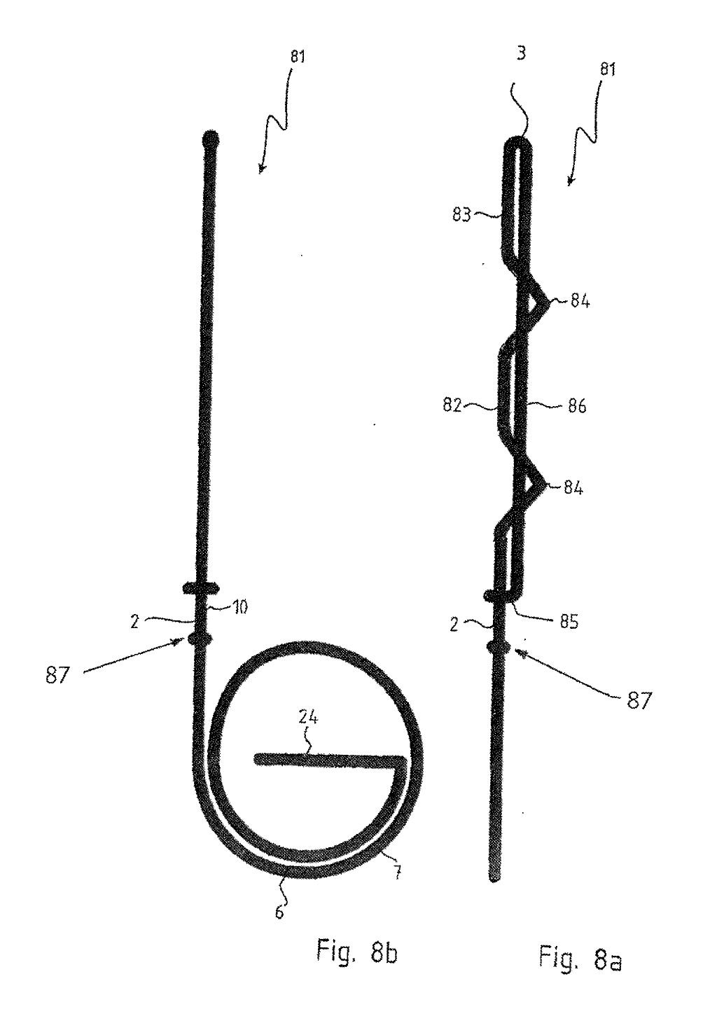

FIGS. 8a-8b show an embodiment of the clamp holder in which the first clamp member is provided with clamp shapes.

FIGS. 1a-1b and 2a-2c illustrate a clamp holder 1 according to the invention in a first embodiment, which comprises a holding element 2. On the holding element 2 a first clamp member 4 for fitting a display means 5, in this case a banner, is constructed on a first, upper end 3. On a second lower end 6 of the holding element 2, a second clamp member 7 is provided with the aid of which the clamp holder 1 is detachably attached to a base 8, a leg of a pair of spectacles 9. The two clamp members 4, 7 are spaced apart from each other by a fixed member 10. The upper first clamp member 4 defines a clamp plane 5a, illustrated by the course of the clamped banner 5, said clamp plane 5a being offset by an angle α, which in this embodiment is about 90°, in relation to a second clamp plane 8a defined by the lower second clamp member 7, said clamp plane 8a being indicated by the course of the spectacle leg 8, as can be seen particularly in FIG. 1b.

The first clamp member 4 has four parallel legs 11-14. Two legs each 11-14 are connected by a cross-member 15-17. In a lateral view, therefore, the first clamp member 4 is essentially constructed in a spiral shape. The lower second clamp member 7 is formed by two helices 18, 19, one of the helices 18 having two protrusions 20, 21 pointing radially outwards, which make it easier to fix the clamp holder 1 onto a base 8. The holding element 2 is manufactured from a piece of wire 22 in a bending machine. The wire 22 contains spring steel. One end 23 of the wire 22 in the lower second clamp member 7 protrudes inwards to the centre and forms a bearing element 24, which braces the clamp holder 1 against the base 8 onto which it is fixed, as can be seen particularly in FIG. 1. This end 23 of the wire 22 is bent in an L-shape.

FIG. 3a-3c illustrates another embodiment of the clamp holder 31. The same features in this embodiment compared to that in FIG. 1 or 2 are given identical reference numerals. In this clamp holder, the first clamp member 32 has three parallel legs 33-35 whereby in each case two are connected by cross-members 36, 37 at the end. Viewed from the side, the wire 22, from which the first clamp member 32 is bent, also runs spirally inwards.

For attaching display means 5 particularly made of board, the wire 22 in the first clamp member 7, 32 can have an undulating section. Due to the undulating section, the friction resistance is slightly increased so that the display means 5 is guaranteed to have a particularly secure grip on the clamp holder 1, 31.

FIG. 4a-4b shows an embodiment of a second clamp member 41 in which the wire end 42 reaching inwards is bent into a round eye 43. In this way, the width of the bearing element 24 is increased. Furthermore, the bearing element 24 has no sharp-edged end 42.

Incidentally, the same features in this embodiment compared to those in FIG. 1 to 3 are given identical reference numerals.

FIG. 5a-5c shows an embodiment of the clamp holder 51 in which the first clamp member 52 has two helices 53, 54 spaced apart from each other. In each coil 55, the wire 22 is wound by at least a full revolution in each case, preferably by at least two revolutions. A display means can be clamped between the coils 55.

Moreover, the same features in this embodiment compared to those in FIG. 1 to 4 are given identical reference numerals.

FIG. 6 shows a clamp holder 51, as is known from FIG. 5a-5c, in which a cover element 62 is detachably attached to a helix 61 of the lower second clamp member 56. In this example, the cover element 62 is clipped in. A flat external surface 63 of the cover element 62 is printed with a logo 64, in this case a ying-yang symbol. However, the external surface 63 of the cover element 62 can also be convex. On the reverse side, the cover element 62 can have widened engaging means or fixed members which fill up the free spaces in the helix above and below the bearing element and penetrate through the second clamp member so that they contribute to stabilising and safeguarding the second clamp member 56 on the base.

Further features which are the same in this embodiment compared to those in FIG. 1 to 5 are given identical reference numerals.

FIG. 7 shows a clamp holder 71 which is constructed, as in FIG. 3a-3c, with a three-leg first clamp member 4. In addition, the fixed member 72 is bent by an angle β. Incidentally, the same features are given identical reference numerals.

In the embodiment of the clamp holder 81 according to FIG. 8a-8b, a first leg 82 of the first clamp member 83 is provided with two V-shaped clamp shapes 84 spaced apart from each other, which enlarge the clamp surface for inserted display means. The end 85 of the second leg 86 encompasses the first leg 82.

The wire 22 of the holding element 2 can be provided with either a coating or sheathing. Brass plating or a paint coating is preferred. A multi-colour paint coating is further preferred in order to be able to design club colours.

In order to prevent injuries, each end 23 of the wire 22 of the holding element 2 is smoothed. In this arrangement, they are particularly chamfered.

Reference numerals

```
  1—Clamp holder
  2—Holding element
  3—Upper end of 2
  4—First clamp member
  5—Display means
  5a—First clamp plane
  6—Lower end of 2
  7—Second clamp member
  8—Base
  8a—Second clamp plane
  9—Spectacles
10—Fixed member
11—Leg
12—Leg
13—Leg
14—Leg
15—Cross-member
16—Cross-member
17—Cross-member
18—Helix
19—Helix
20—Protrusion
21—Protrusion
22—Wire
23—End of 22
24—Bearing element
31—Clamp holder
32—First clamp member
33—Leg
34—Leg
35—Leg
36—Cross-member
37—Cross-member
41—Clamp member
42—Wire end
43—Eye
51—Clamp holder
52—First clamp member
53—Helix
54—Helix
55—Coil
56—Second clamp member
61—Helix
62—Cover element
63—External surface
64—Logo
71—Clamp holder
72—Fixed member
81—Clamp holder
82—First leg
83—Clamp member
84—Clamp shape
85—End of 86
86—Second leg
87—Reference bending point
```

1. Clamp holder for attaching a display means to a base comprising a holding element, provided at a first end with a first clamp member for fitting the display means and at a second end with a second clamp member for attaching the holding element to the base, the clamp members being spaced apart from each other by a fixed member and the first clamp member defining a first clamp plane, which is offset by an angle (α) to a second clamp plane defined by the second clamp member.

2. Clamp holder according to claim 1 characterised in that the angle (α) is a right angle (90°.

3. Clamp holder according to claim 1 characterised in that the first clamp member has at least two legs running parallel to each other.

4. Clamp holder according to claim 3 characterised in that one of the legs has at least a preferably V-shaped clamp shape.

5. Clamp holder according to claim 3 characterised in that one of the legs positively encompasses another leg with a leg end.

6. Clamp holder according to claim 1 characterised in that at least one of the clamp members has a helix or a spiral.

7. Clamp holder according to claim 6 characterised in that a helix or a spiral has at least a protrusion.

8. Clamp holder according to claim 6 characterised in that the clamp member has several legs or spirals spaced apart from each other.

9. Clamp holder according to claim 6 characterised in that a cover element is detachably attached to a helix or a spiral.

10. Clamp holder according to claim 9 characterised in that the cover element has a printed outer surface.

11. Clamp holder according to claim 1 characterised in that the holder element is designed in one piece.

12. Clamp holder according to claim 1 characterised in that the holder element is manufactured from a piece of wire by bending.

13. Clamp holder according to claim 1 characterised in that the holder element is manufactured by injection moulding.

14. Clamp holder according to claim 1 characterised in that the holder element is manufactured by sheet stamping.

15. Clamp holder according to claim 1 characterised in that an end in a clamp member protrudes inwards and forms a bearing element.

16. Clamp holder according to claim 1 characterised in that the end of the wire reaching inwards is bent into an L-shape or Z-shape.

17. Clamp holder according to claim 1 characterised in that the end of the wire reaching inwards has an eyelet.

18. Clamp holder according to claim 12 characterised in that the wire is provided with a coating.

19. Clamp holder according to claim 12 characterised in that the wire is provided with a sheathing.

20. Clamp holder according to claim 12 characterised in that the wire has at least a smoothed end.

21. Clamp holder according to claim 12 characterised in that the wire in a clamp member has an undulating section.

22. Clamp holder according to claim 12 characterised in that the wire is manufactured from spring steel.

23. Clamp holder according to claim 1 claims characterised in that the fixed member is bent at an angle (β).

24. Clamp holder according to claim 1 characterised in that the display means is a card or a flag.

25. Clamp holder according to claim 1 characterised in that a reference bending point is pressed into the fixed member.
